(19) United States
(12) Patent Application Publication
(10) Pub. No.: US 2010/0326853 A1
(43) Pub. Date: Dec. 30, 2010

(54) Disc Case

(76) Inventor: Aleksandra Vukotic, Mermaid Beach (AU)

Correspondence Address: MICHAEL MOLINS;MOLINS & CO., SUITE 5, LEVEL 6, 139 MACQUARIE ST, SYDNEY NSW, 2000, AU

(21) Appl. No.: 12/879,007

(22) Filed: Sep. 10, 2010

Related U.S. Application Data
(62) Division of application No. 12/166,313, filed on Jul. 1, 2008.

(51) Int. Cl. G11B 33/04

(52) U.S. Cl. 206/308.1

(57) ABSTRACT

A disc case for a CD or DVD disc has a first portion separated from a second portion by a fold-line which enables the portions to move about the fold-line relative to each other. Each portion has at least one pocket to hold the disc. The case is made from a flexible textile sheet material.

### FIELD OF THE INVENTION

The present invention relates to container or case for holding a CD or DVD disc for storage or transporting purposes. References to disc in the specification generally refers to CD and DVD discs but is not limited to these disc types.

### BACKGROUND OF THE INVENTION

The present United States patent application is a divisional of U.S. patent application Ser. No. 12/166,313, filed Jul. 1, 2008.

With the development of information technology, discs have increasingly been used because of their ability to store large amounts of information.

The discs are stored in plastic cases often referred to as jewel cases. Each jewel case is generally made of two plastic parts that are hinged together. One part contains a central boss to receive the disc through the central hole of the disc while the other part of the jewel case forms a lid to enclose the disc within the jewel case. Jewel cases that can accommodate multiple discs have additional parts to hold more discs in place. The assembly of multiple parts of a jewel case adds to the complexity and costs of manufacturing the final product.

With collection of discs, storage of the discs in their individual jewel cases becomes impractical due to space limitations in office and homes. Another way of storing discs has been the use of purpose designed paper envelopes with a clear face that have been developed to hold discs and prevent them from being scratched. A further alternative has been the development of cardboard holders where the design of some of these cardboard holders are of the type that can open like a book and have pockets on each side. The use of paper envelopes and cardboard folders allow discs to be stored in a more compact manner. Whilst addressing the problem of limited storage space in offices and homes, paper envelopes and cardboard folders can be easily bent and therefore do not provide sufficient protection to the discs. Furthermore, each disc cannot be conveniently displayed in a paper envelope or cardboard folder.

### OBJECT OF THE INVENTION

It is an object of the present invention to provide a disc case for a disc that overcomes in part at least one or more of the above mentioned disadvantages.

### SUMMARY OF THE INVENTION

In one aspect the present invention broadly resides in a disc case for a CD or DVD including:

a first portion separated from a second portion by a fold-line which enables the portions to move about the fold-line relative to each other, each portion has at least one pocket to hold the disc wherein the pocket of each portion opposes each other and enclosed when the disc case is closed, each pocket has securing means to secure the disc within the pocket, each portion has a closure member that is positionable an outer surface of one of the portions to maintain the disc case in a closed position.

Preferably the disc case is a one piece disc case.

The securing means preferably includes a boss that receives a disc in a snap- fitting arrangement.

Alternatively, the securing means includes a retainer positionable over part of the disc to substantially prevent displacement of the disc from the pocket. The retainer may be a tab integrally formed with the portion and engageable with a peripheral edge of the disc. In a different embodiment of the disc case, the retainer may be a flap formed within the portion. The flap may be covered by a protector to prevent damage to the disc. The protector is preferably a strip of material that is positioned over the flap to enclose the disc within the disc case.

The fold-line is preferably centrally located between the first and second portions.

Preferably, the first portion is the same shape and size as the second portion so the disc case is symmetrical about the fold-line. Each pocket is preferably substantially triangular in shape. Preferably the pocket has an opening that is at least the diameter of the disc. The pocket is preferably dimensioned to have a depth that encloses at least half of the disc within the pocket.

In one embodiment of the invention, each portion has a plurality of pockets and each pocket overlaps with at least one other pocket to enable discs to be retained in the pockets in an arrangement forming a row whereby one disc is slightly offset from an adjacent disc.

The first and second portions preferably each has a closure member to support the first and second portions in a standing position for displaying the discs.

The closure members are preferably foldable over the outer surface of one of the portions. The closure members preferably support the case in an upright position when it is opened.

Preferably, the closure member is a flat edge portion formed by folding a peripheral section of one portion.

Preferably, the closure member is triangular in shape.

The disc case is preferably made of a flexible plastic. An exterior face of each of the first and second portions preferably has printed words or graphics that describe or promote contents of the disc.

In another embodiment the disc case as described above has side portions that are foldable to overlie an internal surface of the portions when the disc case is closed. Preferably the side portions cover a disc within the pocket to substantially prevent dislodgement or loss of the disc when the disc case is closed. More preferably the side portions are inwardly foldable and cover the exposed section of the disc in the pocket.

Preferably, a plurality of disc cases can be stored in a disc case holder. The disc case holder is preferably a folder with a plurality of sleeves to retain the disc cases.

In a further aspect of the invention broadly resides in a disc case holder including a plurality of sleeves for locating one or more disc cases as described above.

### BRIEF DESCRIPTION OF THE DRAWING FIGURES

In order that the present invention can be more readily understood reference will now be made to the accompanying drawings which illustrate preferred embodiments of the invention and where:

FIG. 1 is a diagrammatic view of a disc case according to a first preferred embodiment of the invention and shown in an opened position;

FIG. 2 is a diagrammatic view of an opened upright disc case shown in FIG. 1;

FIG. 3 is another diagrammatic view of the standing disc case shown in FIG. 1;

FIG. 4 is a diagrammatic view of the closed disc case shown in FIG. 1;

FIG. 5 is a diagrammatic view of an opened disc case of a second preferred embodiment of the invention;

FIG. 6 is a diagrammatic view of an opened and upright disc case shown in FIG. 5;

FIG. 7 is another diagrammatic view of the standing disc case shown in FIG. 5;

FIG. 8 is a diagrammatic view of an opened disc case of a third preferred embodiment of the invention;

FIG. 9 is a diagrammatic view of the disc case shown in FIG. 8 showing the side sections folded inwardly;

FIG. 10 is another diagrammatic view of the disc case shown in FIG. 8 showing the foldable sections in a folded arrangement;

FIG. 11 is a diagrammatic view of the disc case shown in FIG. 8 in a closed position;

FIG. 12 is a diagrammatic view of the disc case shown in FIG. 8 shown chained to other similar disc cases;

FIG. 13 is a diagrammatic view of a part folded disc case of a fourth preferred embodiment of the invention;

FIG. 14 is a diagrammatic view of the disc case shown in FIG. 13 showing the foldable sections in a folded arrangement; and

FIG. 15 is a plan view of a blank from which a case is formed.

### DETAINED DESCRIPTION OF THE PREFERRED EMBODIMENT

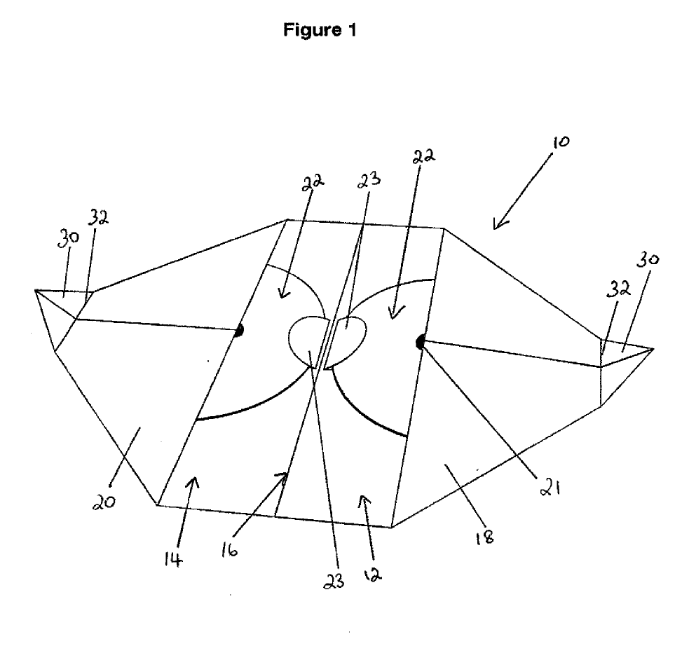

With reference to FIGS. 1 to 4, there is shown a one-piece or integral disc case 10 for holding a CD or DVD disc. The disc case 10 has two preferably continuous or integral portions 12, 14 that are separated by a common fold-line 16. The two portions 12, 14 are the same shape and size forming a disc case that is symmetrical about the fold-line 16. The two portions 12, 14 have a substantially triangular shape with the apex of the triangle furthest from the fold-line 16.

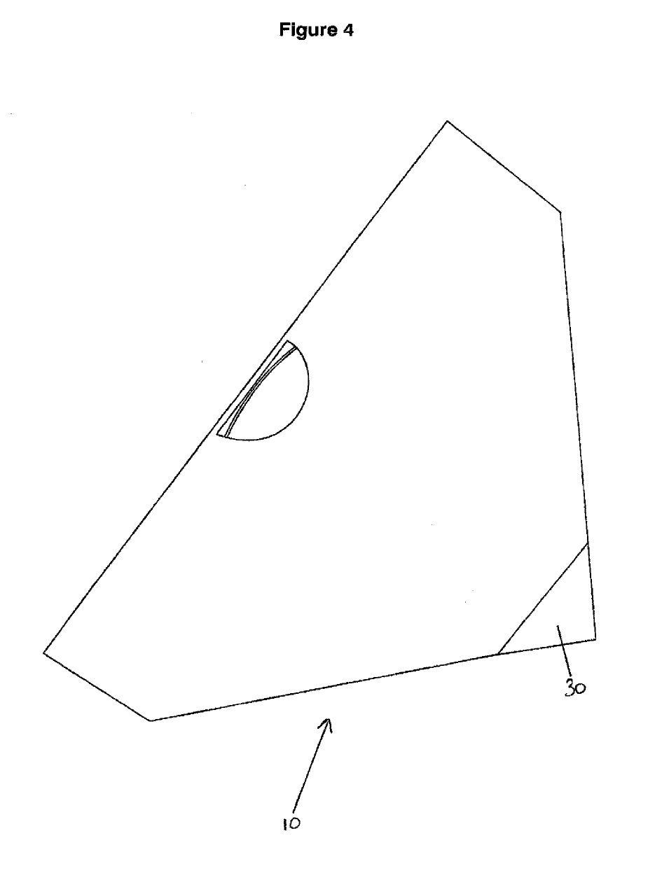

The fold-line 16 is located in the centre of the disc case 10. The fold-line 16 enables one portion to move relative to the other by pivoting about the fold- line 16. This allows the two portions 12, 14 to move from an opened position as shown in FIG. 1 to a closed position as shown in FIG. 4.

Each portion 12, 14 has one folded pocket 18, 20 respectively for holding a disc 22 which can be a CD or DVD. The folded pocked is sub-divided by a longitudinal slit formed from edges of the sheet. Each folded pocket 18, 20 has an optional boss 21 that engages with the central hole of the disc 22 to retain the disc 22 within the pocket 18, 20. The boss 21 is designed so that the disc 22 can snap-fit onto the boss 21. The first preferred embodiment of the disc case 10 has a retainer flap 23 that can engage and retain an exposed section of the disc 22 when it is positioned within a pocket 18, 20. The retainer flap 23 can be formed as a cut-out from each portion or a protrusion extending from each portion. The retainer flap 23 is preferably position adjacent the fold-line 16.

Another embodiment may not have the retainer flap relying on the boss to position and hold the disc within the pocket.

A further embodiment may have side portions that upon closure of the disc case, fold inwardly to overlap the exposed section of the position disc to prevent the disc from accidental removal from the pocket.

When the disc case 10 is open, the pockets 18, 20 are on the same side of the disc case 10 as shown in FIG. 1. When the disc case 10 is opened, the pockets 18, 20 substantially oppose each other and a disc 22 can be inserted or removed from the each of the pockets 18, 20. When the disc case 10 is closed, the pockets 18, 20 are folded about the fold-line 16 to be on top of each other and be no longer accessible. The discs are stored away in the closed position. As each pocket 18, 20 sits flat against each portion 12, 14, the disc case 10 is less bulky compared with jewel cases. This allows more disc cases to be stacked one upon another to provide an efficient method for storing the discs where space is limiting.

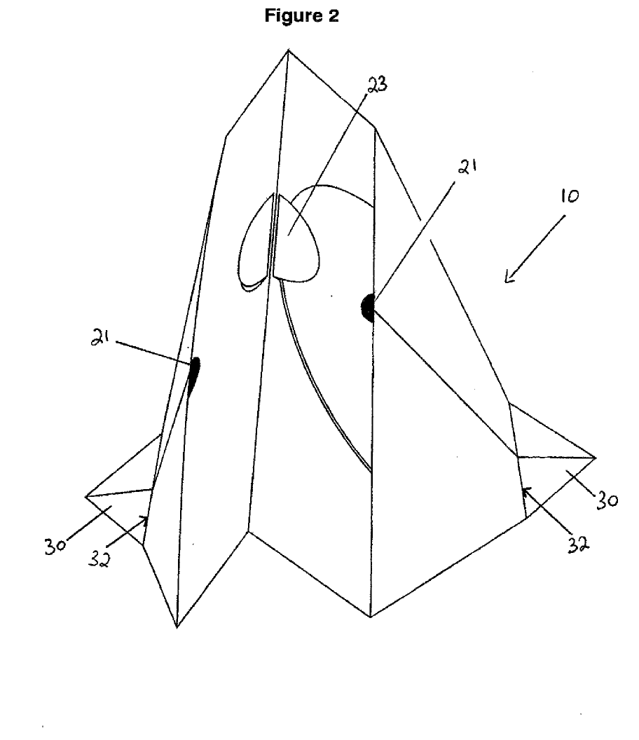

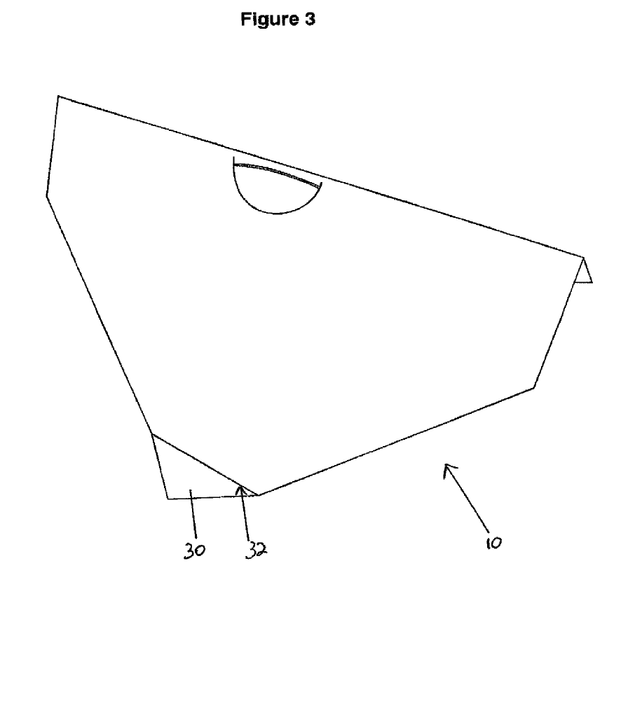

The fold-line 16 of disc case 10 enables each portion 12 or 14 to be moved 180 degrees relative to the other portion 12 or 14. This allows the two portions to be placed in a standing position as shown in FIG. 2 for displaying the discs 22 and in FIG. 3 in the substantially closed position. Each of the portions 12, 14 are supported in a standing position by a support portion 30 located at the apex of the portion 12, 14. Each support portion 30 is a small triangular section defined by a fold-line 32 along its base. The support portions 30 also serve to maintain the disc case 10 in a closed position by folding one support portion backwards and folding another support portion forwards to overlay the backwards folded support portion.

The disc case 10 is made of a flexible plastic material that can protect the stored discs from being bent and damaged. The disc case 10 is preferably formed as a one-piece item and the boss 21 is formed from integrally and continuously the same plastic, paper or composite substrate textile sheet material as the case.

The disc case can be made in other shapes. For example, the two pockets may be two semi-circles and the support portions can be semi-circular in shape.

Each pocket of the preferred embodiment, shown in the figures, can cover at least half of the disc when the disc is positioned within the pocket. However, a pocket may be able to cover more than half of the disc providing the opening of the cover is not less than the diameter of the disc.

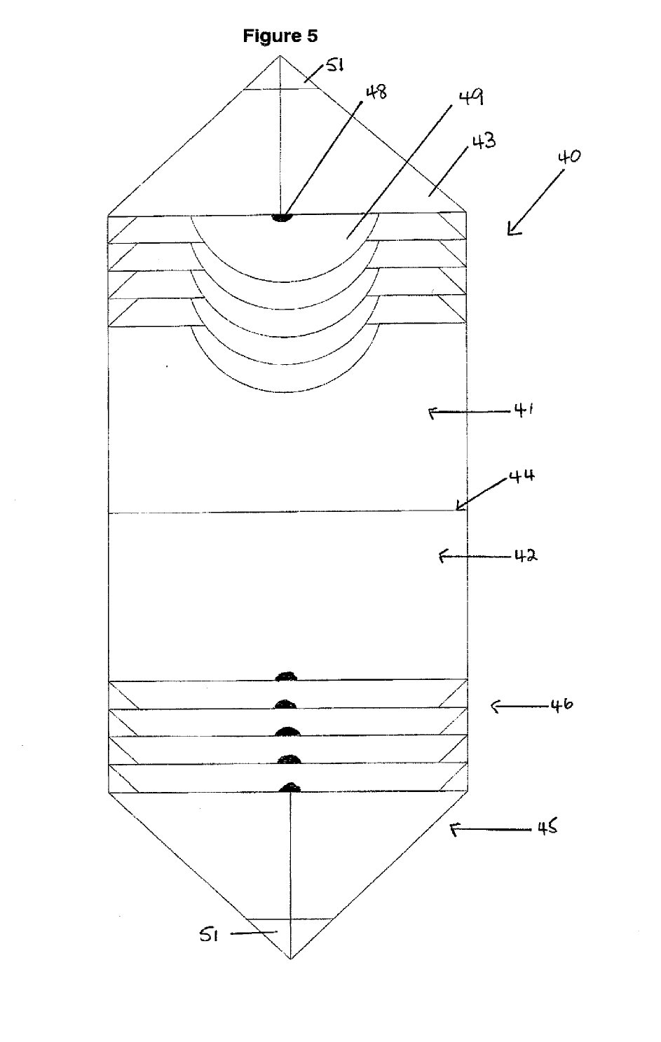

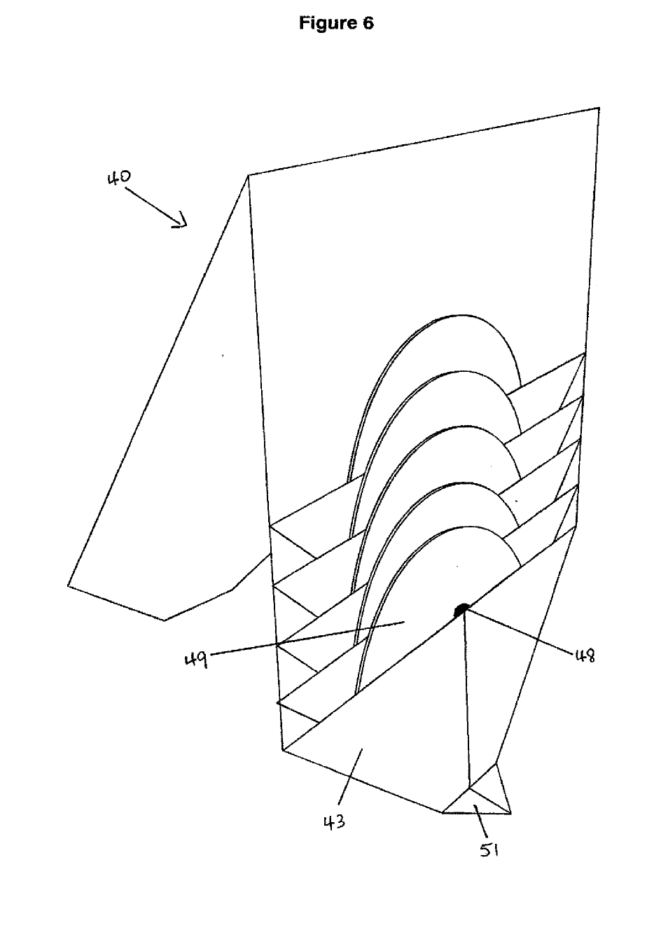

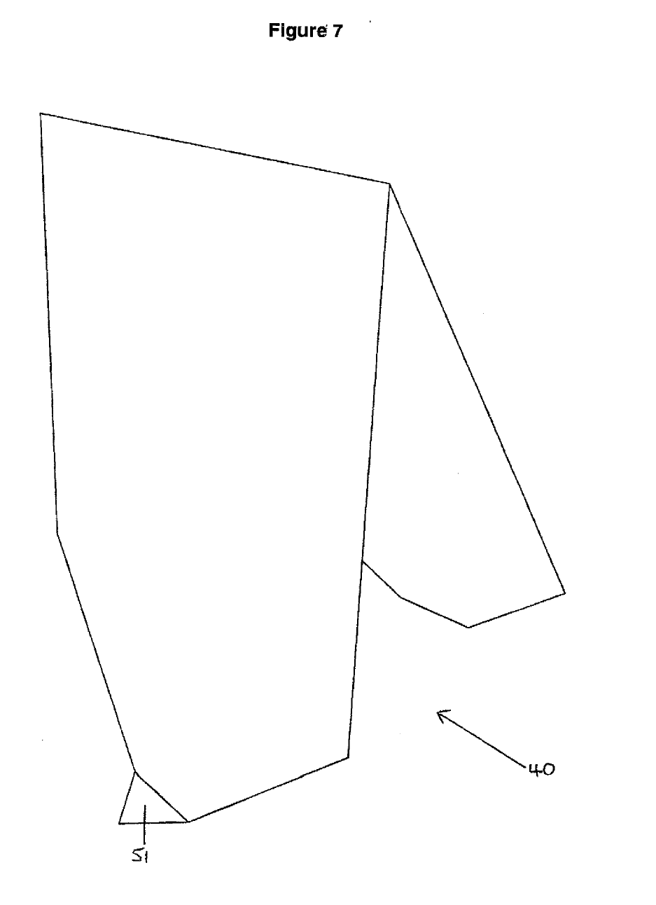

In FIGS. 5 to 7, there is shown a multi-stack disc case 40 having two portions 41, 42 with a plurality of pockets 43 on each portion 41, 42. The disc case 40 has a fold-line 44 separating the portions 41, 42. Like the first embodiment, each portion 41, 42 can fold about the fold-line 44 to open and close the disc case 40.

Each portion 41, 42 has a substantially triangular section 45 and a rectangular section 46. The length of the rectangular section 46 depends on the number of pockets 43. Where there are more triangular pockets 43, the rectangular section 42 will be longer.

Each of the pockets 43 has a boss 48 for engaging and retaining the disc 49. Each pocket 43 overlaps an adjacent pocket 43 so that the discs 49 are retained in the pockets 43 where one disc 49 is slightly offset from another disc 49. This allows multiple discs to be stored in a single disc case. This provides a very effective method of storing discs where space is limited.

Like the first preferred embodiment, there is a triangular support portion 51 associated with each portion 41, 42 that can support the disc case 40 in an upright position and also serve as a closure when the disc case 40 is closed.

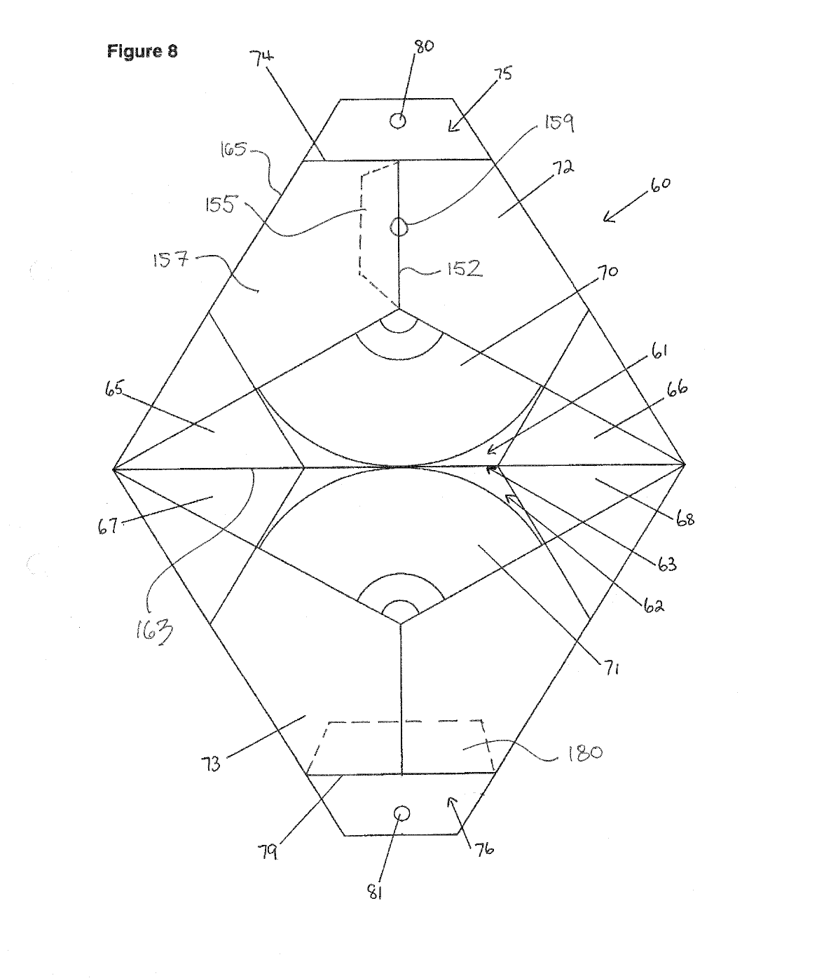

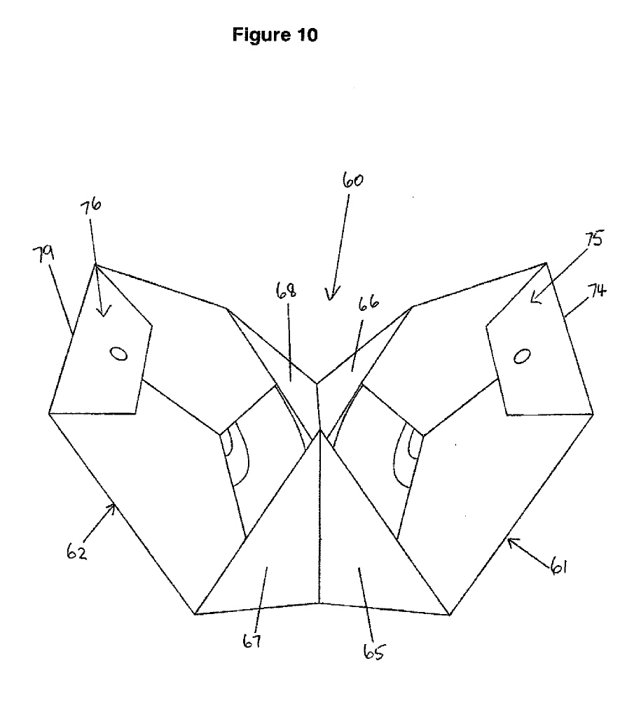

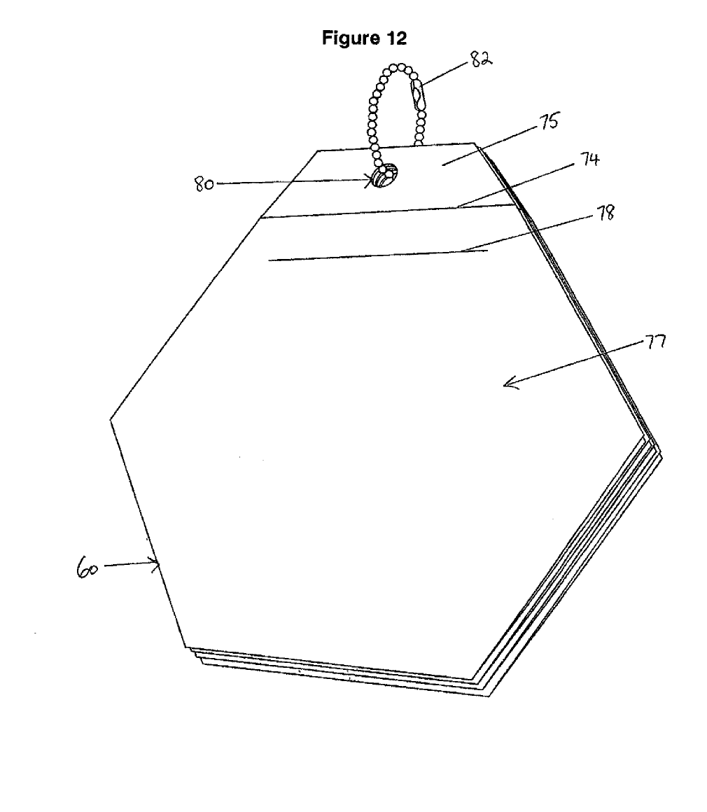

In FIGS. 8 to 12, there is shown a third preferred embodiment of a disc case 60. The disc case 60 is a one-piece disc case with two portions 61, 62 that are separated by a fold line 63. Each portion includes a folded pocket for a disc. The folded pocked is sub-divided by a longitudinal slit formed from edges of the sheet. The disc case 60 is similar to the disc case 10 described above except that the disc case 60 has four side sections 65, 66, 67, 68 that are inwardly foldable to overlie the internal surface of the portions 61, 62 when the disc case 60 is closed. The side sections forming two opposing lateral pleats 65, 67 and 66, 68. Each pleat e.g. 65 with 67 or 66 with 68 serves to secure one side of one or both adjacent discs 70, 71 within its respective pocket 72, 73. The side sections 65, 66 work together and fold inwardly and cover the exposed section of one disc 70 in the pocket 72 to substantially prevent dislodgement or loss of the disc 70 when the disc case 60 is closed. The side sections 67, 68 perform the same function as the corresponding and symmetrical side portions 65, 66. When the side sections 65, 66 67, 68 are folded inwardly, each of the portions 61, 62 is hexagonal in shape.

In further embodiment, not shown in the figures, there may be a boss (as previously described) on each of the portions 61, 62 (in addition to side sections 65, 66, 67 68) to hold a disc within the pocket.

As suggested in Figure ii, each portion 61, 62 has a free end 75 , 76 that is foldable along end fold-lines 74, 79 . The foldable free end 75 on portion 61 can be folded over the outer surface 77 of the opposed portion 62 to maintain the disc case 60 in a closed position. The foldable free end 75 serves as a closure and can be held in a slit 78 formed in a portion 62.

There is preferably an aperture 80, 81 in each of the free ends 75 , 76. When the free ends 75 , 76 are not folded, a security chain 82 can be passed through the apertures 80, 81 e.g. to chain the disc case 60 to several other disc cases.

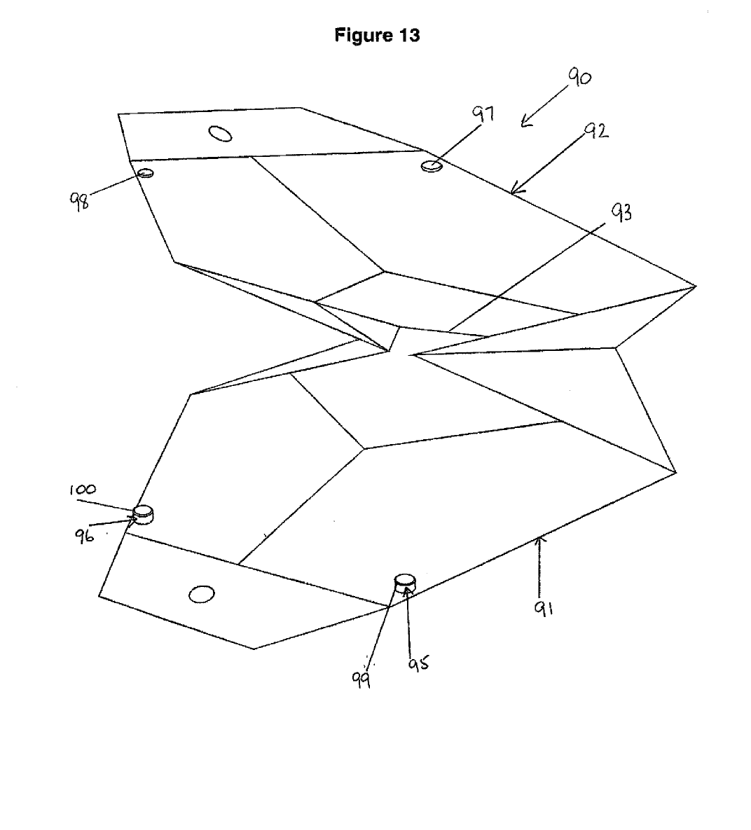

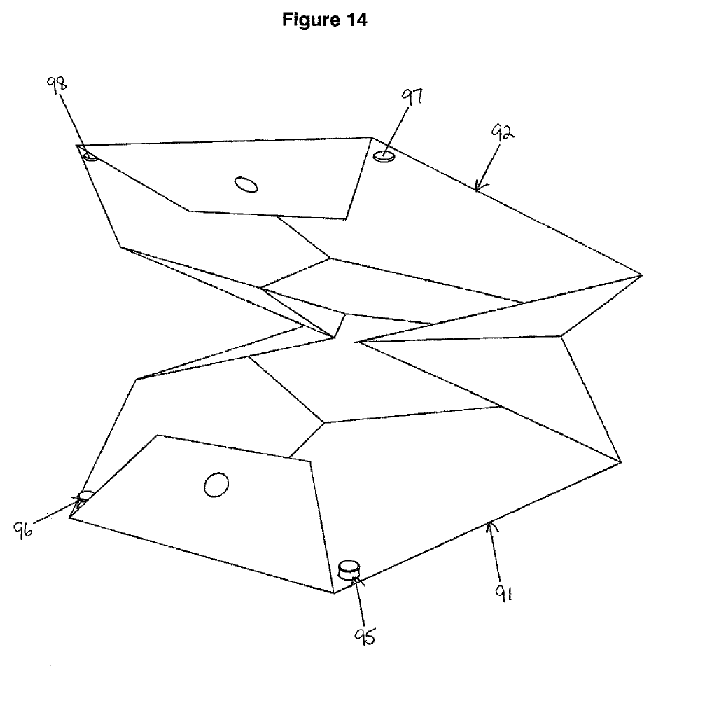

In FIGS. 13 and 14, there is shown a fourth preferred embodiment of a disc case 90. The disc case 90 is a one-piece disc case with two portions 91, 92 that are separated by a fold line 93 . The disc case 90 is similar to the disc case 60 described above except that on one portion 91 of the disc case 90 there are two studs 95, 96 that can be passed through two stud apertures 97 , 98 respectively located in the opposed portion 92. The studs 95 , 96 and stud apertures 97 , 98 serve as a closure to maintain the disc case 90 in a closed position. The lip 99 , 100 of each std 95 , 96 respectively substantially prevents inadvertent withdrawal or dislodgement of the studs form the stud apertures. In another embodiment the stud apertures may be recesses and the studs are snap-fitted within the recesses.

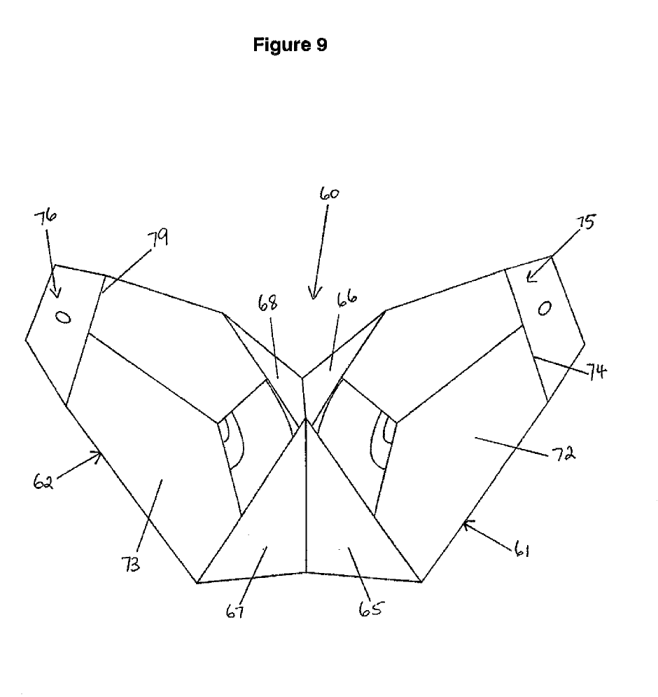

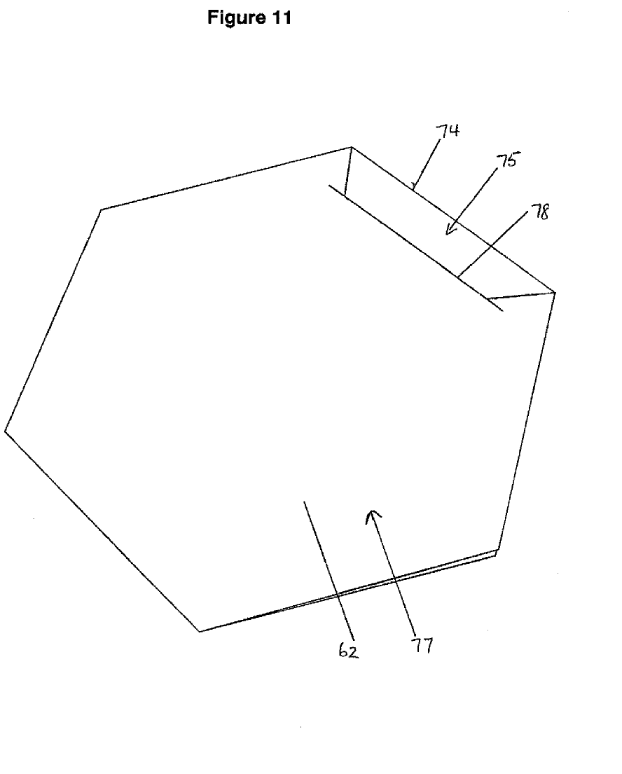

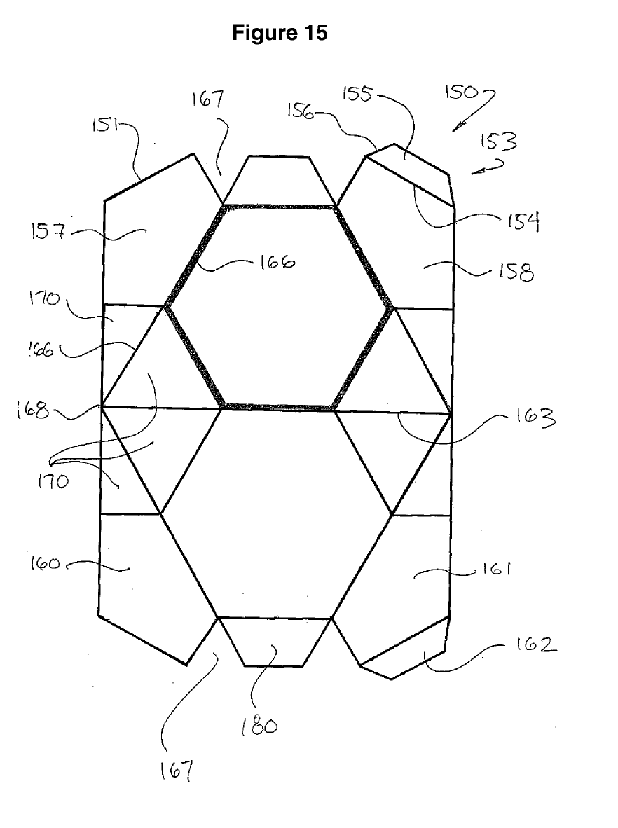

A blank 150 for forming a case according to the teachings of the present invention is depicted, in plan view, in FIG. 15 . The blank may be used to form a case similar to the ones depicted in FIGS. 8-14. The blank is preferably formed by a semi-rigid board or other textile or polymer sheet approximately 31 cm long and about 21.5 cm wide. One corner 151 of the blank has been cut back or bevelled so as to form one half of the flap and medial slit 152 shown in FIG. 8. The corner of the other side 153 has a fold line 154 that is a mirror image of the cut corner line 151. The blank has a tab 155 with truncated corners 156 that protrudes beyond the fold line 154. As shown better in FIG. 8, a tab 155 extends beneath the retention flap 157 and the two adjacent retention flaps 157 , 158 are held together and closed by a small adhesive fastener 159. A similar arrangement of retention flaps and tab 160, 161, 162 are located in the lower half of the blank 150. The two halves are separated by a central transverse fold line 163. Again with reference to FIGS. 8 and 15, it can be seen that an external edge 165 of a disc pocket is defined by a fold line 166 that extends from a notch 167 to a central lateral point 168. The part of the fold line 166 that extends beyond the external edge 165 forms a fold line in a complex of lateral pleats 170 that correspond to the symmetrical side portions 65 , 66 discussed above. The pleats fold inwardly to produce the type of structure seen in Figure 9 . The blank 150 also includes a peak flap 180 that may be utilised, as, for example, the foldable free end 75 seen in FIG. 8 or folded and tucked under the disc retention flaps as shown in the lower half of FIG. 8. Thus, the upper and lower edges of the blank are characterised by triangular notches 167 , located to either side of the longitudinal centre line and define edges of the flap 180. Thus, it will be appreciated that the blank depicted in FIG. 15 is adapted to produce a case for two discs that when folded, form the finished hexagonal case shape depicted, for example, in the embodiments suggested by FIGS. 8-14. It will be appreciated that each of the external edges of the final hexagonal shape are defined by fold lines, e.g. 166, 163 and that these same fold lines contribute to the formation of the various flaps and pleats that are used in the fabrication of the case. In the example depicted in FIG. 15 , only the peripheral edges of the blank are cut and no cutting is required apart form these, excluding the optional slit 78 depicted in FIG. 11. It will also be appreciated that there is considerable latitude in the configuration of the size and shape of the peak flap 180 and the optional tabs 155 , 162.

Advantages

The advantages of the preferred embodiment of the present invention include providing a very efficient method of storing discs using minimal space. Multiple discs can be stored in the disc case in a space efficient manner. The preferred embodiment of the present invention is a one piece disc case which is relatively robust and does not require assembly prior to use.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

What is claimed is:

1. A disc case comprising:
a first textile sheet portion separated from a second textile sheet portion by a fold-line which enables the portions to move about the fold-line relative to each other;
each portion having one folded pocket to hold a disc wherein the folded pocket of each portion opposes the other and is enclosed when the disc case is closed:
each folded pocket being a hexagonal and being defined by lateral pleats and a pair of adjacent retention flaps.

2. The case of claim 1, wherein:
a pocket has a securing means to secure the disc within the pocket.

3. The case of claim 1, wherein:
the case is a one piece case.

4. The case of claim 2, wherein:
the securing means is a boss formed from the sheet portion.

5. The case of claim 1, further comprising:
at least one peak flap having an aperture formed in it.

6. The case of claim 1, further comprising:
a retainer positionable over part of the disc to substantially prevent displacement of the disc from the pocket.

7. The case of claim 1, further comprising:
at least one peak flap may have a free end that can be inserted into a slit formed in one of the sheet portions.

8. The case of claim 1, wherein:
the fold-line is preferably centrally located between the first and second portions.

9. The case of claim 1, wherein:
the first portion is the same shape and size as the second portion so the case is symmetrical about the fold-line.

10. The case of claim 1, wherein:
the case is made of at least one of a flexible paper, composite or plastic.

11. The case of claim 1, wherein:
the lateral pleats fold inward and are adapted to retain an adjacent disc.

12. The case of claim 1, wherein:
a folded pocket further comprises a longitudinal slit.

13. The case of claim 1, wherein:
one portion has a peak flap with a free end that is foldable along an end fold-line so that the peak flap can be folded over an outer surface of an opposed portion and held in a slit formed in that opposed portion.

14. The case of claim 1, wherein:
each portion folds into a hexagonal shape.

15. The case of claim 1, wherein:
on one portion of the disc case there are formed one or more studs that can be passed through one or more stud apertures respectively located in an opposed portion.
